(19) United States
(12) Patent Application Publication
(10) Pub. No.: US 2026/0200698 A1
(43) Pub. Date: Jul. 16, 2026

(54) METHOD AND APPARATUS FOR PROVIDING HOISTWAY ACCESS SECURITY IN A LIFT SYSTEM

(71) Applicant: Otis Elevator Company, Farmington, CT (US)

(72) Inventors: Xiaobin Tang, Tianjin (CN); Honglin Liu, Shanghai (CN)

(21) Appl. No.: 19/397,039

(22) Filed: Nov. 21, 2025

(30) Foreign Application Priority Data
Jan. 14, 2025 (CN) 202510061612.X

(51) Int. Cl. B66B 5/00

(52) U.S. Cl. CPC B66B 5/0056

(57) ABSTRACT

A method and device for providing hoistway access safety in an elevator system. In a method for providing hoistway access safety in an elevator system, the elevator system includes a plurality of landing door switches, which are grouped to construct a plurality of safety chains. In this method, the elevator system is enabled to enter a first operation mode that prohibits car movement, in response to an event of at least two safety chains of the plurality of safety chains entering a disconnected state. Then, the elevator system is enabled to enter a second operation mode that causes the car to reach a safety position, in response to an event of the plurality of safety chains entering a closed state. The safety position is determined based on the position where the car stops when the event of the plurality of safety chains entering a closed state occurs.

### FOREIGN PRIORITY

This application claims priority to Chinese Patent Application No. 202510061612.X, filed Jan. 14, 2025, and all the benefits accruing therefrom under 35 U.S.C. § 119, the contents of which in its entirety are herein incorporated by reference.

### TECHNICAL FIELD OF INVENTION

The present disclosure relates to an elevator technology, and in particular to a method and device for providing hoistway access safety in an elevator system, an elevator system comprising the device, a non-transitory computer-readable storage medium storing computer programs/instructions for implementing the method, and a computer program product comprising computer programs/instructions for implementing the method.

### BACKGROUND OF THE INVENTION

In a typical maintenance scenario, the elevator maintenance personnel should press the emergency stop button before entering the hoistway of an elevator to keep the car in a static state, but this safety measure is not foolproof. In this connection, an hoistway access detection (HAD) mechanism can be utilized to provide more safety assurance. In a method for implementing this mechanism, an elevator controller detects the presence of foreign matters in the elevator hoistway by monitoring changes in the strength of the wireless signal in the elevator hoistway, and stops the elevator operation once the presence is detected to prevent accidents.

### SUMMARY OF THE INVENTION

In a method for providing hoistway access safety in an elevator system according to one aspect of the present disclosure, the elevator system comprises a plurality of landing door switches, which are grouped to construct a plurality of safety chains. In this method, the elevator system is enabled to enter a first operation mode that prohibits car movement, in response to an event of at least two safety chains of the plurality of safety chains entering a disconnected state. Then, the elevator system is enabled to enter a second operation mode that causes the car to reach a safety position, in response to an event of the plurality of safety chains entering a closed state. The safety position is determined based on the position where the car stops when the event of the plurality of safety chains entering a closed state occurs.

In a device for providing hoistway access safety in an elevator system according to another aspect of the present disclosure, the elevator system comprises a plurality of landing door switches, which are grouped to construct a plurality of safety chains. The device comprises at least one processor, at least one memory, and computer programs/instructions stored on the memory. When executed on the processor, the computer programs/instructed cause the following operations: first, enabling the elevator system to enter a first operation mode that prohibits car movement, in response to an event of at least two safety chains of the plurality of safety chains entering a disconnected state; then, enabling the elevator system to enter a second operation mode that causes the car to reach a safety position, in response to an event of the plurality of safety chains entering a closed state. The safety position is determined based on the position where the car stops when the event of the plurality of safety chains entering a closed state occurs.

The elevator system according to yet another aspect of the present disclosure comprises a car disposed in the hoistway and capable of moving between a plurality of landings when in operation, a control unit, a driver coupled to the control unit, and a plurality of landing door switches. The driver causes the car to move or stop in response to commands of the control unit. The landing door switches are grouped to construct a plurality of safety chains. The control unit enables the elevator system to enter a first operation mode that prohibits car movement, in response to an event of at least two safety chains of the plurality of safety chains entering a disconnected state, and then enables the elevator system to enter a second operation mode that causes the car to reach a safety position, in response to an event of the plurality of safety chains entering a closed state. The safety position is determined based on the position where the car stops when the event of the plurality of safety chains entering a closed state occurs.

According to still another aspect of the present disclosure, there is provided a computer-readable storage medium with computer programs/instructions stored thereon suitable for execution on a processor of a terminal device, and the execution of the computer programs/instructions causes the steps of the method described above to be performed.

According to a further aspect of the present disclosure, there is provided a computer program product comprising computer programs/instructions, and the execution of the computer programs/instructions causes the steps of the method described above to be performed.

### BRIEF DESCRIPTION OF THE DRAWINGS

The above and/or other aspects and advantages of the present disclosure will become clearer and easier to understand in conjunction with the following description in various aspects of the drawings. The same or similar units in the drawings are represented by the same reference numerals. The drawings include:

FIG. 1 shows an exemplary diagram of an elevator system.

FIGS. 2A-2C show examples of a method for determining the traveling direction of a car according to some embodiments of the present disclosure.

FIG. 3 shows a schematic block diagram of an elevator system according to one embodiment of the present disclosure.

FIG. 4 shows a flow diagram of a method for providing hoistway access safety in an elevator system according to another embodiment of the present disclosure.

FIG. 5 shows a flow diagram of a method for providing hoistway access safety in an elevator system according to yet another embodiment of the present disclosure.

FIG. 6 shows a schematic block diagram of a device for providing hoistway access safety in an elevator system according to some other embodiments of the present disclosure.

### DETAILED DESCRIPTION OF THE INVENTION

The present disclosure will be more fully described hereinafter with reference to the drawings of the exemplary embodiments of the present disclosure. However, the present disclosure may be implemented in different forms, and should not be construed as being limited only by the various embodiments provided herein. The various embodiments aim to make the present disclosure more comprehensive and complete, so that the protection scope of the present disclosure would be more fully conveyed to a person skilled in the art.

In this specification, the terms such as “comprise” and “include” indicate that in addition to the units and steps directly and explicitly stated in the specification and claims, the technical solution of the present disclosure also does not exclude the circumstances where there are other units and steps that are not directly or explicitly stated.

In this specification, a landing generally refers to the location on each floor where passengers (such as individuals and machine devices) enter or exit the car.

In this specification, the term “stop” generally refers to the situation where an elevator car remains stationary at the location of a specific landing or at a location between landings.

In this specification, a safety position refers to, in various locations where the car can stop or has stopped, the position which can provide higher safety for the living entities located inside and outside the car. It can be either the position of a landing where the car can safely stop or a position between landings where the car can stop. The meaning of the aforementioned safety can vary depending on specific application scenarios. For example, in an elevator maintenance scenario, higher safety is represented as decreasing the danger of the maintenance personnel located on top of the car from being squeezed by the car.

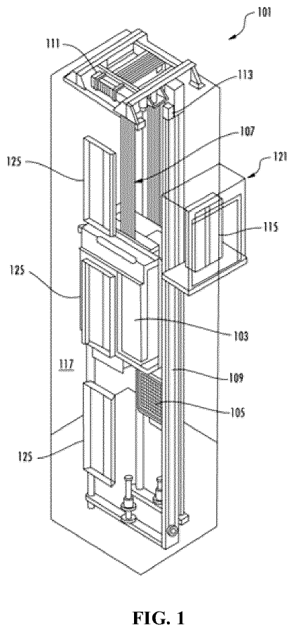

FIG. 1 shows an exemplary diagram of an elevator system. The elevator system 101 illustrated in FIG. 1 includes an elevator car 103, a counterweight 105, a tension member 107, a guide rail (or rail system) 109, a unit (or unit system) 111, a position reference system 113 and an electronic elevator controller (controller) 115. The elevator car 103 and the counterweight 105 may be coupled to each other by the tension member 107. The tension member 107 may include or be configured as, for example, a rope, a steel cable and/or a coated steel strip. The counterweight 105 is configured to balance the load of the elevator car 103, and is configured to facilitate moving the elevator car 103 within the elevator shaft (or hoistway) 117 and along the guide rail 109 relative to the counterweight 105 in the opposite direction and simultaneously.

The tension member 107 may be coupled to the unit 111 which may form part of the overhead structure of the elevator system 101. The unit 111 is configured to control movement between the elevator car 103 and the counterweight 105. The position reference system 113 may be installed on a fixed portion at the top of the elevator shaft 117, for example, on a support member or guide rail, and may be configured to provide position signals regarding the position of the elevator car 103 in the elevator shaft 117. In other embodiments, the position reference system 113 may be installed directly on a mobile component of the unit 111, or may be located in other positions and/or configurations known in the art. The position reference system 113 may be any device or mechanism known in the art for monitoring the position of the elevator car and/or the counterweight. As may be understood by a person skilled in the art, the position reference system 113, for example, includes but is not limited to encoders, sensors or other systems, and may perform various sensing such as velocity sensing, absolute position sensing and the like.

As shown therein, the controller 115 is located in a control room 121 of the elevator shaft 117, and is configured to control the operation of the elevator system 101 (and in particular, the elevator car 103). For example, the controller 115 may send drive signals to the unit 111 to control acceleration, deceleration, levelling, stopping etc. of the elevator car 103. The controller 115 may also be configured to receive position signals from the position reference system 113 or any other desirable position reference device. When moving up or down along the guide rail 109 within the elevator shaft 117, the elevator car 103 may stop at one or more landings 125 as controlled by the controller 115. In spite of being illustrated in the control room 121, a person skilled in the art will appreciate that the controller 115 may be located and/or configured in other places or positions within the elevator system 101. In one embodiment, the controller may be remotely located or positioned in the cloud.

The unit 111 may include a motor or a similar driving mechanism. According to the embodiments of the present disclosure, the unit 111 is configured to include an electrically driven motor. The power supply of the motor may be any power source, including a power grid, and the power source in combination with other components are supplied to the motor. The unit 111 may include traction sheaves which impart a force to the tension member 107 so as to move the elevator car 103 within the elevator shaft 117.

The elevator system 101 illustrated in FIG. 1 commonly comprises a plurality of door interlock devices (not shown), each being installed on the corresponding landing door. The elevator system 101 further comprises landing door switches (not shown) for detecting the locked state and the unlocked state of the door interlock devices, and these landing door switches are connected in series to construct safety chains. During the elevator operation, an operating signal indicating the on-off state of the safety chains is sent to the controller 115, so that the latter can correctly operate the elevator car. However, in the above design, the controller cannot determine the number of the landing door switches in a disconnected state based on disconnection of the safety chains, let alone locate the landing door switches in a disconnected state.

In some embodiments of the present disclosure, to reduce the uncertainty of the above design, the landing door switches are grouped and a plurality of landing door switch groups are utilized to construct a plurality of safety chains. For example, for n landing door switches, they can be grouped into m landing door switch groups (where m≤n), and the landing door switches within each landing door switch group are connected in series to construct corresponding safety chains, thereby obtaining m safety chains.

The hoistway access safety mechanism can be implemented by using the safety chains constructed in the above manner. Generally, when the elevator system malfunctions and needs maintenance, both the landing door of the ith floor where the car stops and the landing door of the (i+1)th floor (the upper floor) may be in an open state. The feature described above can be utilized to determine whether the hoistway access safety mechanism is triggered. Specifically, the event of at least two safety chains entering a disconnected state (which means at least two landing door switches are simultaneously in a disconnected state or at least two landing doors are simultaneously in an open state) can be set as a trigger condition for the elevator system to enter a first operation mode or a stop mode (hereinafter referred to as a first trigger condition). In the first operation mode, the car is prohibited from movement or remains stationary. On the other hand, the event of m safety chains all entering a closed state can be set as a trigger condition for the elevator system to enter a second operation mode or a rescue mode from the first operation mode (hereinafter referred to as a second trigger condition). In the second operation mode, the elevator system causes the car to stop at the safety position. The method for determining the safety position will be hereinafter described in detail.

In a method for implementing the hoistway access safety mechanism with wireless communication technology, the presence of foreign matters in the hoistway can be determined by comparing the strength of a received signal with a strength threshold. The complexity of the internal spatial structure of the hoistway poses great challenges to the setting of a strength threshold. In addition, given the difference in operating environments, it is necessary to set an individualized strength threshold for each elevator system through on-site field measurement. By using grouped switching door switches to construct a plurality of safety chains, the above deficiencies can be effectively avoided.

In some embodiments of the present disclosure, to ensure that the state of the landing door switches of adjacent floors being simultaneously disconnected can be detected, the landing door switches of adjacent floors are either divided into different groups or belong to different safety chains.

In one embodiment, each landing door switch can be utilized to construct a corresponding safety chain. In other words, each safety chain only includes landing door switches corresponding to a landing. Therefore, n landing door switches can be utilized to construct n safety chains (where m=n). In this embodiment, the on-off state of each landing door switch can be independently determined. It should be noted that under the circumstance where there are two or more landing doors for the same floor (which means in n landing door switches, there are two or more landing door switches associated with the same floor), the landing door switches associate with the same floor can be connected in series to construct a safety chain.

In another embodiment, a plurality of safety chains can be constructed in the manner of “staggered grouping”. Specifically, for n landing door switches, it is assumed that they are represented as DS1, DS2 . . . DSn in the order of the associated floors, wherein 1, 2 . . . n represent the serial number of the landing door switch. In this embodiment, a remainder operation can be performed by taking the serial number of a landing door switch and the number of safety chains m (where m<n) as the dividend and the divisor respectively, and the corresponding safety chain is constructed by connecting the landing door switches with the same remainder in series. In other words, each safety chain will include the landing door switches with the same remainder. In one example, assuming that the number of landing door switches is 10 and the number of safety chains is 3, the landing door switches DS1, DS4, DS7 and DS10 will construct a safety chain SC1, the landing door switches DS2, DS5, DS8 will construct a safety chain SC2, and the landing door switches DS3, DS6, DS9 will construct a safety chain SC3.

It should be noted that the above staggered grouping method can also be applied to the circumstance where in n landing door switches, there are two or more landing door switches associated with the same floor. Exemplarily, it is assumed that n landing door switches are represented as DS1, DS2 . . . DSi, DS′i, DSi+1 . . . DSn in the order of the associated floors, wherein the landing door switches DSi and DS′i are associated with the same floor (the ith floor). Since the landing door switches DSi and DS′i have the same serial number, they still belong to the same safety chain. Compared with the method of construction that each safety chain only includes landing door switches corresponding to a landing, the staggered grouping method reduces the number of safety chains while providing sufficient positioning information. As noted above, when the car stops on the ith floor, the elevator maintenance personnel will typically reach the top of the car via the landing door of the (i+1)th floor (the upper floor). This means the landing door switches DSi and DSi+1 corresponding to the ith floor and the adjacent (i+1)th floor are in a disconnected state at the same time. Since the aforementioned staggered grouping method can ensure that the landing door switches of adjacent floors belong to different safety chains, the landing door switches of adjacent floors being simultaneously in a disconnected state will inevitably lead to the event of two safety chains being simultaneously in a disconnected state, thereby providing sufficient positioning information about the landing door switches in a disconnected state.

It should be noted that, apart from the above staggered grouping method, other methods may also be used to divide the landing door switches of adjacent floors into different groups, so as to achieve the various technical effects as described above. For example, the following embodiment can be used:

Exemplarily, it is assumed that n landing door switches are represented as DS1, DS2 . . . DSn in the order of the associated floors. A first array A1 comprising a plurality of elements can be defined, wherein the element dp[i][j] in the array A1 represents the number of combinations for dividing the first i landing door switches into j groups, where each group at least comprises two landing door switches, and the landing door switches of adjacent floors are not in the same group. A second array A2 comprising a plurality of elements can also be defined, wherein the element prev[i][j] in the array A2 is used to record the previous state of the corresponding element dp[i][j] in the array A1. The previous state as mentioned above indicates an element in the first array A1 used when determining the value of the element dp[i][j]. For example, if the value of dp[i][j] is calculated from the value of dp[i−k]−[j−1], then prev[i][j] can be assigned as (i−k, j−1).

Subsequently, the value of each element in the first array A1 is calculated and the second array A2 is used to record the previous state of each element in the first array. Once the values of all elements in the first array A1 are calculated, a backtracking step is performed. In this step, backtracking can be performed starting from the last element dp[n][m] in the first array A1 to obtain the grouping result, wherein n and m represent the number of landing door switches and the number of landing door switch groups, respectively. In particular, during the backtracking process, the serial number of an initial landing door switch and the serial number of a final landing door switch in the corresponding landing door switch group can be determined based on various elements prev[i][j] in the second array A2, and thus the grouping result of the landing door switches is determined. After the grouping result is obtained, a corresponding safety chain is constructed by connecting the landing door switches within the same landing door switch group in series.

The method for determining the safety position is described hereinafter. As noted above, the elevator system will enter the second operation mode from the first operation mode upon the occurrence of an event that all safety chains enter into a closed state. Generally, there may be more than one candidate positions available for the car to stop at when entering the second operation mode. In some embodiments of the present disclosure, first, it is to determine the vertical positional relationship between the safety position to be selected and the current stopping position of the car (for example, whether the selected safety position is located above or below the current stopping position of the car) or determine the traveling direction of the car. After the traveling direction is determined, a stoppable position (for example, a stoppable landing or a candidate landing) closest to the current stopping position of the car in the traveling direction is determined as the safety landing. It should be noted that the current stopping position of the car refers to the position where the car stops when the event of m safety chains all entering a closed state occurs. This position may be either the position of a landing or the position between two adjacent landings.

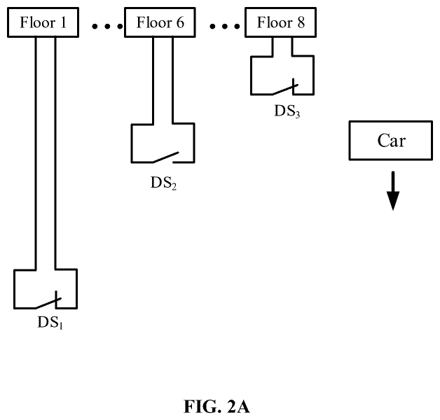

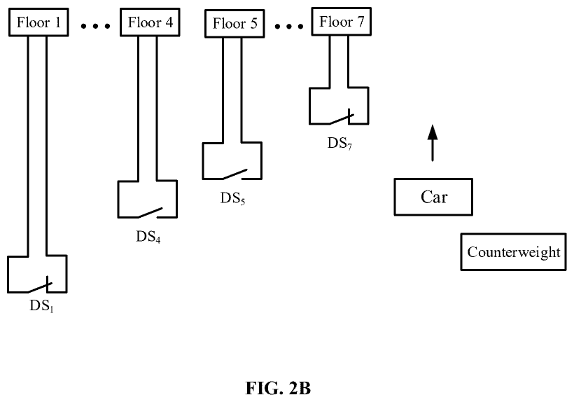

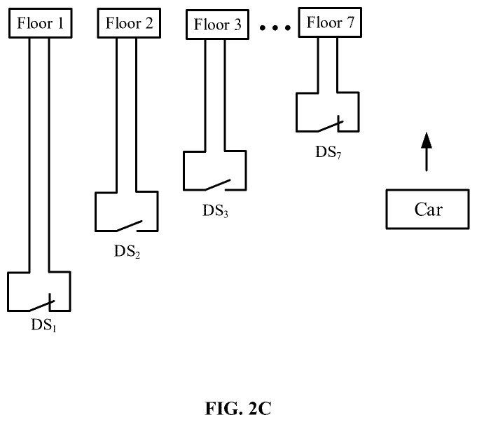

In one embodiment, the current stopping position of the car can be used as a reference, and the direction pointing to a larger free space is determined as the traveling direction of the car. Take the example illustrated in FIG. 2A as an example. When the current landing of the car is located in an upper region of the hoistway (for example, the car stops at the landing on the 6th floor or between the 6th floor and the 7th floor), the downward direction can be determined as the traveling direction. In another example, as illustrated in FIG. 2B, when the current landing of the car is located in a middle region of the hoistway (located at the landing on the 4th floor or between the 3rd floor and the 4th floor in FIG. 2B), given that a counterweight is located below the car, the direction away from the counterweight (the upward direction) is determined as the traveling direction. In yet another example, as illustrated in FIG. 2C, when the current landing of the car is located in a lower region of the hoistway (located at the landing on the 2nd floor or between the 1st floor and the 2nd floor in FIG. 2C), the upward direction can be determined as the traveling direction.

It should be noted that the upper region, the middle region and the lower region described herein may be set based on the structure, the environment configurations and the like of the elevator system (for example, the number of floors, floor height, car height, counterweight volume, etc.). For instance, the region of three floors below the top floor can be set as an upper region, the region of three floors above the ground floor can be set as a lower region, and the region of the remaining floors can be set as a middle region.

Since the traveling direction of the car is a direction pointing to a larger free space, even if due to some reasons, the elevator maintenance personnel remain trapped on top of the car while the car is moving, it is still possible to reduce the possibility of them being squeezed in the hoistway.

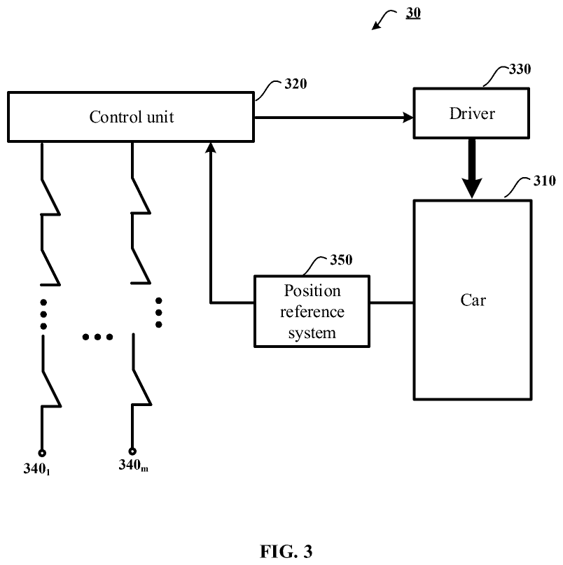

FIG. 3 shows a schematic block diagram of an elevator system according to one embodiment of the present disclosure.

As illustrated in FIG. 3, the elevator system 30 comprises a car 310, a control unit 320 (for example, the controller 115 in FIG. 1), a driver 330 (for example, the unit 111 in FIG. 1) and a plurality of safety chains 3401~340m. Optionally, a car movement detection device 350 (for example, the position reference system 113 in FIG. 1) may also be deemed as a component of the elevator system.

Exemplarily, it is assumed that there are n landings (each landing, for example, may be the landing 125 illustrated in FIG. 1) for the car 310 to stop at. Correspondingly, each landing has respective landing door switches (these landing door switches are hereinafter referred to as DS1~DSn). In some embodiments, the landing door switches DS1~DSn are divided into n landing door switch groups GK1~GKm, and each landing door switch group is used to construct one of the plurality of safety chains 3401~340m. Specifically, for the ith landing door switch group GKi, the landing door switches comprised therein are connected in series to construct the ith safety chain 340i. Referring to FIG. 3, after each safety chain is connected to the control unit 320, the latter is provided with an operating signal indicating the state of the safety chain (a closed state and a disconnected state).

Further referring to FIG. 3, the control unit 320 is coupled to the safety chains 3401~340m, and is configured to monitor the state of the safety chains. Under the condition that the elevator system is in normal operation, after the car stops at a destination floor or landing, the door interlock device of the landing door is switched from a locked state to an unlocked state. Then, the landing door will open, and the corresponding landing door switch will enter a disconnected state and result in the safety chain thereof in a disconnected state.

In the elevator system illustrated in FIG. 3, the control unit 320 is further configured to provide the hoistway access safety mechanism as mentioned above. Exemplarily, the control unit 320 monitors the state of m safety chains. When it is detected that at least two safety chains therein are in a disconnected state, the elevator system will be enabled to enter a first operation mode or stop mode to prohibit car movement. On the other hand, when it is detected that m safety chains all re-enter a closed state, the elevator system will be enabled to enter a second operation mode or rescue mode from the first operation mode. In this mode, the control unit 320 will select a position with high level of stopping safety for the car to stop at that position. Exemplarily, the driver 330 can be utilized to cause the car 310 to travel to the position with high level of stopping safety and stop at that position.

In one embodiment, the control unit 320 can communicate with the car movement detection device 350 (for example, the position reference system 113 in FIG. 1) to obtain the position and movement speed of the car. Exemplarily, the absolute position of the elevator car in the hoistway can be measured by the position reference system 113 and output to the control unit 320. Moreover, the speed of the elevator car can be calculated based on the absolute position and the time associated with the absolute position. Such calculation may be performed by the position reference system 113 and provided to the control unit 320, or may be performed by the control unit 320.

The control functions of the elevator system typically include operational control logic functions (for example, determining the traveling direction of the car, the landing where the car stops and the like in a normal service state), drive control functions (for example, start-up, acceleration, deceleration and stop of the car, etc.) and door driver control functions (for example, opening and closing of the car door, etc.). In the embodiment illustrated by FIG. 3, the control functions of the elevator system and the elevator safety functions (for example, the provision of the aforementioned hoistway access safety mechanism) are implemented by a single control unit; however, this implementation is neither mandatory nor exclusive. In alternative embodiments, the elevator safety functions can be separated, and implemented by using a specialized safety controller or safety control unit (for example, a programmable electronic system in safety related applications for lifts (PESSRAL)).

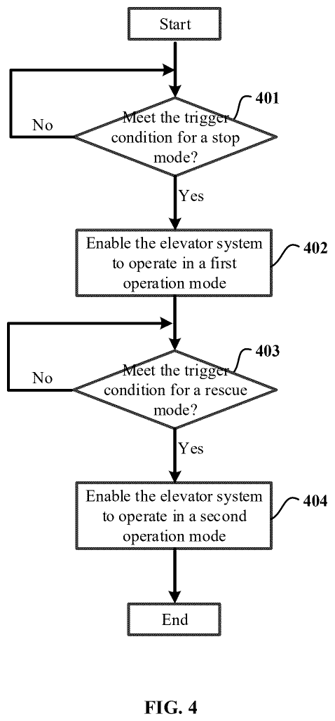

FIG. 4 shows a flow diagram of a method for providing hoistway access safety in an elevator system according to another embodiment of the present disclosure. The method described below can be implemented by various devices. These devices, for example, include but are not limited to a controller (such as the controller 115 in FIG. 1), a safety controller and the like in the elevator system. These devices are hereinafter collectively referred to as a device or control device for providing hoistway access security in the elevator system.

The method illustrated in FIG. 4 starts from step 401. In this step, the control device monitors the state of a plurality of safety chains (for example, the safety chains 3401~340m in FIG. 3) to determine whether the trigger condition for a first operation mode or stop mode is met (for example, whether the event of at least two safety chains entering a disconnected state occurs). If the condition is met, proceed to step 402; otherwise, continue to execute step 401 (for example, in a periodic manner) to determine the state of the safety chains in the subsequent moment.

In this embodiment, just like the previous embodiment, the landing door switches are also divided into a plurality of landing door switch groups, and the landing door switches within each landing door switch group are connected in series to construct a corresponding safety chain. The specific way of dividing the landing door switches has been described in detail above, and will not be repeated here.

Exemplarily, two ends of each safety chain are connected to the power supply and the control device respectively. In the closed state, the operating signal input to the control device is a high-level signal, while in the disconnected state, the operating signal is a low-level signal. In other words, the closed state and the disconnected state of the safety chain can be determined according to the level of the operating signal.

Following step 401, the process illustrated in FIG. 4 proceeds to step 402. In this step, the control device will enable the elevator system to operate in a first operation mode. In this operation mode, the car will be prohibited from movement or remain stationary.

Next, the process proceeds to step 403. In this step, the control device continues to monitor the state of the plurality of safety chains to determine whether the trigger condition for a second operation mode or rescue mode is met (for example, whether the event of all safety chains re-entering a closed state occurs). If the condition is met, proceed to step 404; otherwise, continue to execute step 403 (for example, in a periodic manner) to determine the state of the safety chains in the subsequent moment.

In step 404, the control device will enable the elevator system to work in a second operation mode. In the second operation mode, the elevator system will cause the car to stop at a safety position.

It shall be noted that when the elevator safety functions such as a hoistway access safety mechanism and the like are implemented by independent safety controllers (for example, a programmable electronic system in safety related applications for lifts (PESSRAL)), steps 401, 402, 403 and 404 may have different execution bodies. In other words, steps 401 and 403 can be executed by a safety controller, while steps 402 and 404 can be executed by a controller for controlling the elevator system (such as the controller 115 in FIG. 1). Conversely, when the control functions of the elevator system and the elevator safety functions are integrated in a single control unit, steps 401 to 404 may have the same execution body (such as the control unit 320 in FIG. 3).

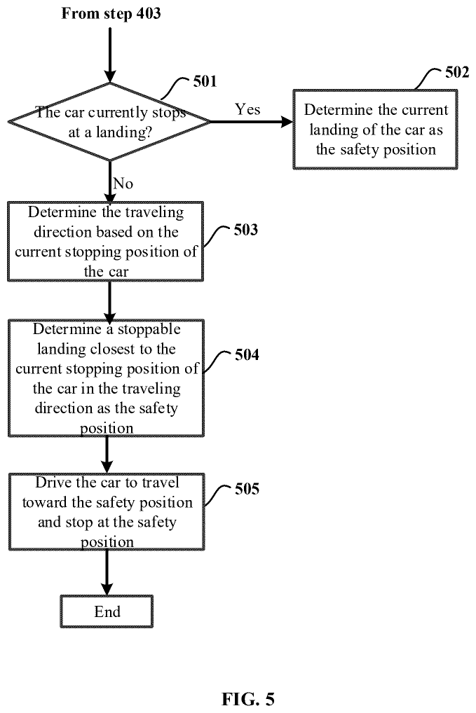

FIG. 5 shows a flow diagram of a method for providing hoistway access safety in an elevator system according to yet another embodiment of the present disclosure. The process illustrated in FIG. 5 can be applied to step 404 in FIG. 4.

The process illustrated in FIG. 5 starts from step 501. This step, for example, can be placed right after step 403 in FIG. 4. In step 501, the control device determines whether the car stops at one landing of a plurality of landings. If yes, proceed to step 502; otherwise, proceed to step 503.

In step 502, the control device determines the current landing of the car as the safety position.

In step 503, the control device determines the traveling direction of the car based on its current stopping position in the hoistway. The method for determining the traveling direction has been described in detail above, and will not be repeated here.

Next, the process proceeds to step 504. In this step, the control device determines a stoppable landing closest to the current stopping position of the car in the traveling direction as the safety position. Still take the circumstances illustrated in FIGS. 2A to 2C as an example. For instance, in FIG. 2A, the current landing of the car is located on the 6th floor or between the 6th floor and the 7th floor (the upper region of the hoistway). Assuming that the landing on the 5th floor is not available (for example, the landing door of that landing cannot open) while the landing on the 4th floor is available for the car to stop at, the position of the landing on the 4th floor will be determined as the safety position. For another instance, in FIG. 2B, the current landing of the car is located on the 4th floor or between the 3rd floor and the 4th floor (the middle region of the hoistway). Assuming that the landing on the 5th floor is available for the car to stop at, the position of the landing on the 5th floor will be determined as the safety position. For yet another instance, in FIG. 2C, the current landing of the car is located on the 2nd floor or between the 1st floor and the 2nd floor (the lower region of the hoistway). Assuming that the landing on the 3rd floor is not available while the landing on the 4th floor is available for the car to stop at, the position of the landing on the 4th floor will be determined as the safety position.

Following step 504, the process illustrated in FIG. 5 proceeds to step 505. In this step, the control device generates a control demand based on, for example, the movement speed and position of the car, and sends the control demand to a driving mechanism (such as the unit 111 in FIG. 1) to drive the car to travel toward the safety position determined in step 504 and stop at that safety position.

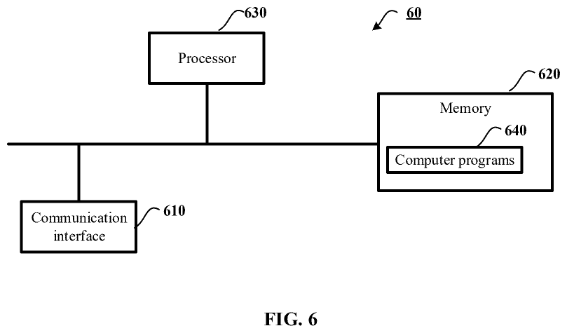

FIG. 6 shows a schematic block diagram of a device for providing hoistway access safety in an elevator system according to some other embodiments of the present disclosure. The device illustrated in FIG. 6 can be used, for example, to implement a controller in an elevator system (such as the controller 115 in FIG. 1) or a safety controller etc.

As illustrated in FIG. 6, the device 60 comprises a communication unit 610, one or more memories 620 (for example, non-volatile memories such as flash memory, ROM, hard disk drive, magnetic disk, optical disk, etc.), one or more processors 630, and computer programs/instructions 640.

The communication unit 610 serves as a communication interface, and is configured to receive control commands and data from an external device (for example, other units in the elevator system (such as the unit 111 and the position reference system 113 in FIG. 1 and the safety chains 3401~340m in FIG. 3) or network (such as internet, wireless local area network, and the like), and send the control commands and data generated at the device 60 to the external device or network.

The memory 620 stores computer programs/instructions 640 executable by the processor 630. In addition, the memory 620 may also store the data generated by the processor 630 when executing the computer programs/instructions 640 and the data (such as the movement speed and position of the car, status signals of the safety chains, and the like) received from the external device via the communication unit 610.

The processor 630 is configured to execute the computer programs/instructions 640 stored on the memory 620 and perform access operations on the memory 620.

The computer programs/instructions 640 may include program codes for implementing the various functions and operations described in FIGS. 2 to 5, so that these functions and operations can be implemented by executing the computer programs/instructions 640 on the processor 630.

Various embodiments of the system and technology described herein may be implemented in a digital electronic circuit system, an integrated circuit system, a field programmable gate array (FPGA), an application-specific integrated circuit (ASIC), an application-specific standard product (ASSP), a system on a chip (SOC), a complex programmable logic device (CPLD), a computer hardware, a firmware, a software, and/or combinations thereof. These various embodiments may include: implementation in one or more computer programs. The one or more computer programs can be executed and/or interpreted on a programmable system including at least one programmable processor. The programmable processor may be a dedicated or general-purpose programmable processor, which may receive data and instructions from a storage system, at least one input device and at least one output device, and transmit the data and instructions to the storage system, the at least one input device and the at least one output device.

The program codes for implementing the method of the present disclosure may be written in one programming language or any combination of more than one programming languages. These program codes may be provided to a processor or controller of a general-purpose computer, a dedicated computer, or other programmable data processing device, so that the program codes, when executed by the processor or controller, cause the functions/operations specified in the flow diagram and/or block diagram to be implemented. The program codes may be executed entirely on a machine or partly on a machine, or may serve as an independent software package to be executed partly on a machine and partly on a remote machine, or entirely on a remote machine or a server.

To demonstrate interchangeability between hardware and software, various illustrative components, blocks, modules, circuits and steps have been described above in general terms based on their functionality. Such functionality is implemented in the form of hardware or software, depending on particular applications and design constraints imposed on the overall system. A person skilled in the art may implement the described functionality in varying ways for particular applications, but such implementation decisions should not be construed to result in a departure from the scope of the present disclosure.

While only some embodiments of the present disclosure are described, it should be understood by a person skilled in the art that the present disclosure can be implemented in various other forms without departing from its main purpose and scope. Therefore, the examples and embodiments provided are intended to be illustrative rather than restrictive, and the present disclosure may encompass various modifications and substitutions without departing from the spirit and scope of the present disclosure as defined in the appended claims.

What is claimed is:

1. A method for providing hoistway access safety in an elevator system, wherein the elevator system comprises a plurality of landing door switches, and the plurality of landing door switches are grouped to construct a plurality of safety chains, the method comprising:
A. enabling the elevator system to enter a first operation mode that prohibits car movement, in response to an event of at least two safety chains of the plurality of safety chains entering a disconnected state; and
B. enabling the elevator system to enter a second operation mode that causes the car to stop at a safety position, in response to an event of the plurality of safety chains entering a closed state, wherein the safety position is determined based on a position where the car stops when the event of the plurality of safety chains entering the closed state occurs.

2. The method according to claim 1, wherein the way of grouping the plurality of landing door switches allows the landing door switches of adjacent floors to belong to different safety chains.

3. The method according to claim 2, wherein each safety chain comprises a landing door switch corresponding to a landing.

4. The device according to claim 2, wherein the way of constructing the safety chain is as follows:
sequencing the plurality of landing door switches in the order of the associated floors;
performing a remainder operation by taking the serial number of a landing door switch and the number of safety chains as a dividend and a divisor respectively; and
enabling each safety chain to comprise the landing door switches with the same remainder.

5. The method according to claim 2, wherein the way of constructing the safety chain is as follows:
sequencing the plurality of landing door switches in the order of the associated floors;
calculating the value of each element in a first array and using a second array to record the previous state of each element in the first array, wherein an element dp[i][j] in the first array represents the number of combinations for dividing the first i landing door switches into j groups, where each group at least comprises two landing door switches, and the landing door switches of adjacent floors are not in the same group, and an element prev[i][j] in the second array is used to record the previous state of the corresponding element dp[i][j] in the first array;
performing backtracking starting from the last element in the first array to obtain the grouping result, wherein the serial number of an initial landing door switch and the serial number of a final landing door switch in the corresponding landing door switch group are determined based on the element prev[i][j] in the second array; and
constructing the corresponding safety chain by connecting the landing door switches within the same landing door switch group in series.

6. The device according to claim 1, wherein the safety position is either the position of a landing where the car can safely stop or the position between adjacent landings where the car can safely stop.

7. The device according to claim 1, wherein step B comprises:
B1. if the car stops at one of a plurality of landings when an event of the plurality of safety chains entering a closed state occurs, determining the landing as the safety position;
B2. if the car stops between two adjacent landings of a plurality of landings when an event of the plurality of safety chains entering a closed state occurs, determining a traveling direction of the car based on the position of the car in the hoistway; and
B3. determining a stoppable landing closest to the current stopping position of the car in the traveling direction as the safety position.

8. The method of claim 7, wherein in step B2, when the current stopping position of the car is located in an upper region of the hoistway, a downward direction is determined as the traveling direction.

9. The method of claim 7, wherein in step B2, when the current stopping position of the car is located in a middle region of the hoistway, the current stopping position of the car serves as a reference, and a direction away from a counterweight is determined as the traveling direction.

10. The method according to claim 7, wherein in step B2, when the current stopping position of the car is located in a lower region of the hoistway, an upward direction is determined as the traveling direction.

11. A device for providing hoistway access safety in an elevator system, wherein the elevator system comprises a plurality of landing door switches, and the plurality of landing door switches are grouped to construct a plurality of safety chains, the device comprising:
at least one processor;
at least one memory; and
computer programs/instructions stored on the memory, when executed on the processor, causing the following operations:
A. enabling the elevator system to enter a first operation mode that prohibits car movement, in response to an event of at least two safety chains of the plurality of safety chains entering a disconnected state; and
B. enabling the elevator system to enter a second operation mode that causes the car to stop at a safety position, in response to an event of the plurality of safety chains entering a closed state, wherein the safety position is determined based on a position where the car stops when the event of the plurality of safety chains entering a closed state occurs.

12. The device according to claim 11, wherein the way of grouping the plurality of landing door switches allows the landing door switches of adjacent floors to belong to different safety chains.

13. The device according to claim 12, wherein each safety chain comprises a landing door switch corresponding to a landing.

14. The device according to claim 12, wherein the way of constructing the safety chain is as follows:
sequencing the plurality of landing door switches in the order of the associated floors;
performing a remainder operation by taking the serial number of a landing door switch and the number of safety chains as a dividend and a divisor respectively; and
enabling each safety chain to comprise the landing door switches with the same remainder.

15. The device according to claim 12, wherein the way of constructing the safety chain is as follows:
sequencing the plurality of landing door switches in the order of the associated floors;
calculating the value of each element in a first array and using a second array to record the previous state of each element in the first array, wherein an element dp[i][j] in the first array represents the number of combinations for dividing the first i landing door switches into j groups, where each group at least comprises two landing door switches, and the landing door switches of adjacent floors are not in the same group, and an element prev[i][j] in the second array is used to record the previous state of the corresponding element dp[i][j] in the first array;
performing backtracking starting from the last element in the first array to obtain the grouping result, wherein the serial number of an initial landing door switch and the serial number of a final landing door switch in the corresponding landing door switch group are determined based on the element prev[i][j] in the second array; and
constructing the corresponding safety chain by connecting the landing door switches within the same landing door switch group in series.

16. The device according to claim 11, wherein the safety position is either the position of a landing where the car can safely stop or the position between adjacent landings where the car can safely stop.

17. The device according to claim 11, wherein operation B comprises:
B1. if the car stops at one of a plurality of landings when an event of the plurality of safety chains entering a closed state occurs, determining the landing as the safety position;
B2. if the car stops between two adjacent landings of a plurality of landings when an event of the plurality of safety chains entering a closed state occurs, determining a traveling direction of the car based on the position of the car in the hoistway; and
B3. determining a stoppable landing closest to the current stopping position of the car in the traveling direction as the safety position.

18. The device according to claim 17, wherein in operation B2, when the current stopping position of the car is located in an upper region of the hoistway, a downward direction is determined as the traveling direction.

19. The device according to claim 17, wherein in operation B2, when the current stopping position of the car is located in a middle region of the hoistway, the current stopping position of the car serves as a reference, and a direction away from a counterweight is determined as the traveling direction.

20. The device according to claim 17, wherein in operation B2, when the current stopping position of the car is located in a lower region of the hoistway, an upward direction is determined as the traveling direction.

21. The device according to claim 11, wherein the device is an elevator controller of the elevator system or a safety controller independent from the elevator controller.

22. An elevator system, comprising:
a car disposed in a hoistway and capable of moving between a plurality of landings when in operation;
a control unit;
a driver coupled to the control unit, the driver being configured to cause the car to move or stop in response to commands of the control unit; and
a plurality of landing door switches, the plurality of landing door switches being grouped to construct a plurality of safety chains,
wherein the control unit is configured to:
A. enable the elevator system to enter a first operation mode that prohibits car movement, in response to an event of at least two safety chains of the plurality of safety chains entering a disconnected state; and
B. enable the elevator system to enter a second operation mode that causes the car to stop at a safety position, in response to an event of the plurality of safety chains entering a closed state, wherein the safety position is determined based on a position where the car stops when the event of the plurality of safety chains entering a closed state occurs.

23. A non-transitory computer-readable storage medium with computer programs/instructions stored thereon, wherein the computer programs/instructions are executed by a processor to perform the steps of the method according to claim 1.
